(19) United States
(12) Patent Application Publication
(10) Pub. No.: US 2009/0117361 A1
(43) Pub. Date: May 7, 2009

(54) Masking Tape

(75) Inventors: Yoshitomo Ono, Saitama (JP); Yumiko Matsubayashi, Saitama (JP); Tadahiro Tomino, Saitama (JP)

Correspondence Address: POSZ LAW GROUP, PLC, 12040 SOUTH LAKES DRIVE, SUITE 101, RESTON, VA, 20191, US

(73) Assignee: Lintec Corporation, Tokyo (JP)

(21) Appl. No.: 11/989,131

(22) PCT Filed: Apr. 24, 2006
(86) PCT No.: PCT/JP2006/308558

§ 371 Date: Jun. 10, 2008

(30) Foreign Application Priority Data
Jul. 26, 2005 (JP) 2005-216689

(51) Int. Cl. B32B 7/12

(52) U.S. Cl. 428/220; 428/343

(57) ABSTRACT

A masking tape 1, which is a masking tape 1 for a long part, comprises a base material 11 and a pressure sensitive adhesive layer 12, such that the tearing resistance of the base material 11 in the width direction is 220 mN/15 mm or more. Preferably, in particular, the base material 11 comprises a material in which a machine direction is generated during manufacture, the machine direction of the base material 11 is the longitudinal direction of the masking tape 1, and the tearing resistance of the base material 11 in a direction perpendicular to the machine direction is 220 mN/15 mm or more. Tape breakage is difficult to occur in such a masking tape 1.

### TECHNICAL FIELD

The present invention relates to a masking tape for a long part, for instance a masking tape for masking the inner bottom face of a slide rail for automobile slide doors.

### BACKGROUND ART

In automobiles such as minivans, wagon cars, RVs (recreational vehicles) and the like a slide door is often used as a rear door. Such a slide door opens and closes by way of a roller provided on the back side of the slide door, such that the roller rolls over an inner bottom face of a slide rail, mounted on the automobile body, that guides the roller. The slide rail is ordinarily an elongate member having an opening along the longitudinal direction thereof, and having one bent end (Patent document 1).

In an automobile manufacturing line, ordinarily, the automobile is painted after the slide rail is mounted on the body. Thereupon, however, a coating film of coating material often is formed to the inside of the slide rail, or a coating mist often attaches to the inside of the slide rail.

When the coating film is formed to the inside of the slide rail, or a coating mist attaches to the inside of the slide rail, however, the surface smoothness of the inner bottom face of the slide rail is impaired, making it harder for the roller that rolls over the inner bottom face of the slide rail to rotate smoothly. This makes for heavier opening and closing of the slide door, and causes vibration of the slide door during opening and closing, among other problems.

For this reason, a separate member such as a metal plate is affixed to the inner bottom face of the slide rail after the coating operation, to impart thereby surface smoothness to the inner bottom face of the slide rail and to ensure a smooth rotation of the roller. Doing so is problematic, however, in that the operation of mounting a separate member on the inner bottom face of the slide rail is troublesome, while manufacturing a separate member incurs additional costs.

Therefore, there have been proposed methods for coating a vehicle body after sticking a masking tape on the inner bottom face of a slide rail, with a view to preventing attachment of a coating material to the a slide rail (Patent document 1 and Patent document 2).

[Patent document 1] Japanese Unexamined Patent Application Laid-open No. 2005-052746
[Patent document 2] Japanese Unexamined Patent Application Laid-open No. 2002-316092

### DISCLOSURE OF THE INVENTION

### Problem to be Solved by the Invention

A masking tape thus stuck on the inner bottom face of the slide rail is exposed to high temperature during coating drying, while the recess positions on which the tape is stuck are subjected to substantial stress when the tape is peeled off, which results in tape breakage during tape peeling. When such tape breakage occurs, the masking tape located at the back of the narrow opening of the slide rail must be removed in a time-consuming operation.

The present invention has been devised in view of the above state of affairs; it is an object of the present invention to provide a masking tape for a long part that is not prone to tape breakage.

### Means for Solving the Problem

To attain the above object, the present invention provides a masking tape for a long part, comprising a base material and a pressure sensitive adhesive layer, wherein the tearing resistance of the base material in the width direction is 220 mN/15 mm or more (Invention 1).

Tape breakage is likely to occur during peeling of a masking tape for a long part, with the fracture surface extending in the width direction. In the above invention (Invention 1), however, tape breakage during peeling can be prevented by maintaining high tearing resistance in the width direction of the masking tape.

In the above invention (Invention 1), preferably, the base material comprises a material in which a machine direction is generated during manufacture; the machine direction of the base material is a longitudinal direction of the masking tape; and the tearing resistance of the base material in a direction perpendicular to the machine direction is 220 mN/15 mm or more (Invention 2). Herein, “machine direction” denotes the direction along the flow of the base material as it is manufactured in a manufacturing apparatus.

In a material where a machine direction is generated during manufacture, the tearing resistance in a direction perpendicular to the machine direction is ordinarily higher than the tearing resistance in the machine direction, and hence the base material can be used with good efficiency by matching the direction where tape breakage is likelier to occur and the direction in which the tearing resistance of the base material is higher, as in the above invention (Invention 2).

In the above inventions (Inventions 1 and 2), the base material comprises preferably a material having a melting point of 180° C. or above (Invention 3). Deformation of the base material during coating drying is thus prevented by using a base material having such a melting point, since the upper limit of the coating drying temperature is ordinarily less than 180° C.

In the masking tape according to the above inventions (Inventions 1 to 3), the adhesive strength against a stainless-steel adherend after heating at 180° C. for 1 hour is preferably 4 to 10 N/15 mm (Invention 4). The adhesive strength is measured in accordance with JIS Z0237. The adhesive strength within such a range allows preventing lifting of the masking tape during the coating drying operation, and allows also ensuring peelability of the masking tape during peeling of the masking tape, thereby preventing tape breakage.

Such a tape breakage preventing effect is particularly effective when the above masking tape has a width of 5 to 20 mm and a length of 450 mm or more (Invention 5), or when the above masking tape is a masking tape for masking the inner bottom face of a slide rail for an automobile slide door (Invention 6).

### ADVANTAGEOUS EFFECT OF THE INVENTION

The invention provides a masking tape, for use in a long part, in which tape breakage is unlikely.

### BRIEF DESCRIPTION OF THE DRAWINGS

FIG. 1 is a plan view of a masking tape according to an embodiment of the present invention;

FIG. 2 is a cross-sectional view of the masking tape according to the embodiment;

FIG. 3 is a perspective view of a slide rail in which there is used the masking tape according to the embodiment; and

FIG. 4 is a front view of a slide rail in which there is used the masking tape according to the embodiment.

### EXPLANATION OF REFERENCE NUMERALS

1 . . . masking tape
   11 . . . base material
   12 . . . pressure sensitive adhesive layer
   13 . . . release sheet
2 . . . slide rail
   21 . . . rail top
   22 . . . rail rear
   23 . . . rail bottom
   24 . . . flange
   231 . . . inner bottom face

### BEST MODE FOR CARRYING OUT THE INVENTION

An embodiment of the present invention is explained next with reference to accompanying drawings. In the present embodiment there is explained an example of an inner bottom face of a slide rail for an automobile slide door as the long part. However, the long part of the present invention is not limited thereto.

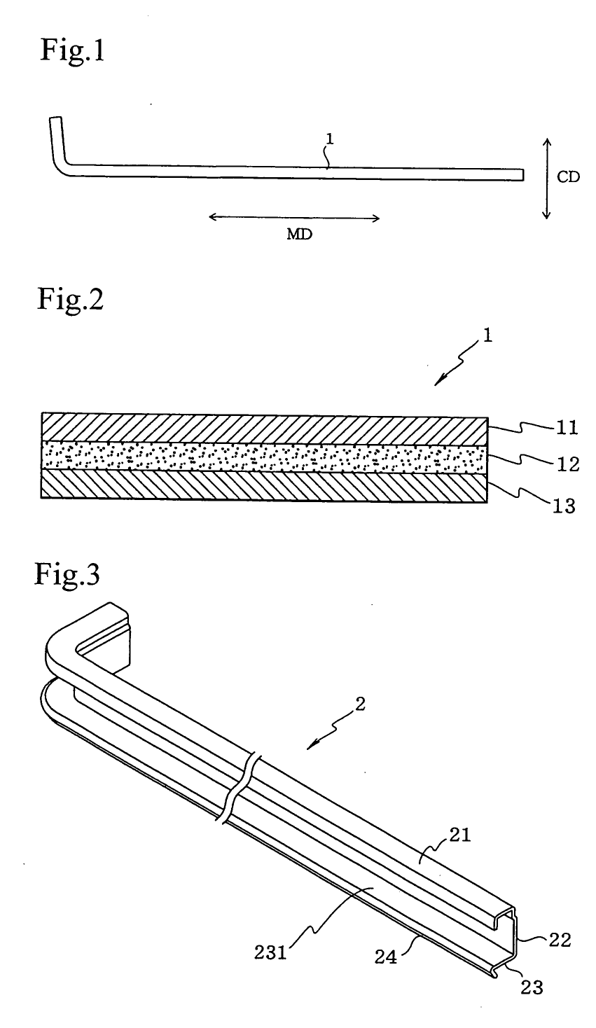

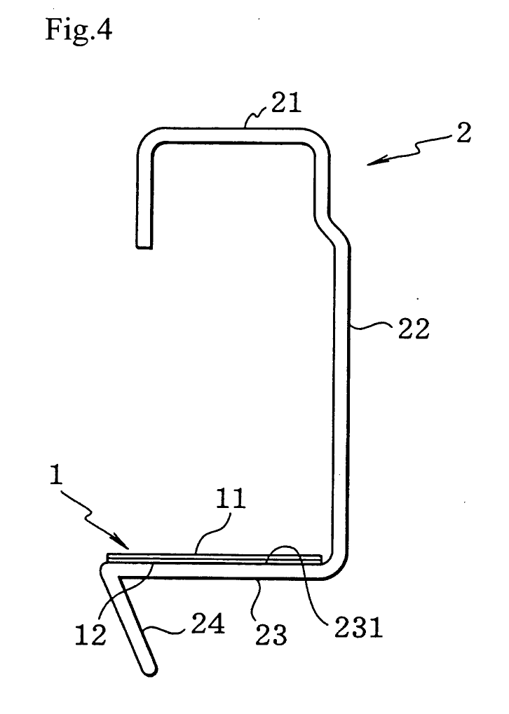

FIGS. 1 and 2 are a plan view and a cross-sectional view of a masking tape according to an embodiment of the present invention, while FIGS. 3 and 4 are a perspective view and a front view of a slide rail using the masking tape according to the embodiment.

As illustrated in FIGS. 3 and 4, a slide rail 2 in the present embodiment comprises a rail top 21 having a cross section shaped substantially as a C opening downwards; a rail rear 22 continued to the back-side lower end of the rail top 21 and provided in a vertical direction; a rail bottom 23 continued to the lower end of the rail rear 22 and provided in a horizontal direction stretching forwards; and a flange 24 continued to the front end of the rail bottom 23 and provided obliquely so as to form an acute angle with the rail bottom 23. Herein, one end of the slide rail 2 in the longitudinal direction is bent. In the slide rail 2 having such a shape, the surface of the rail bottom 23, i.e. an inner bottom face 231 of the slide rail 2, is the face to be masked by the masking tape 1.

As illustrated in FIG. 1, the masking tape 1 stuck on the inner bottom face 231 of the slide rail 2 has a shape corresponding to the inner bottom face 231 of the slide rail 2, and has one end thereof in the longitudinal direction bent in the same way as the slide rail 2. The width of the masking tape 1 is ordinarily of 5 to 20 mm, while the length thereof (on the basis of a straightened bent portion) is ordinarily of 450 to 1200 mm, preferably of 500 to 1100 mm.

As illustrated in FIG. 2, the masking tape 1 according to the present embodiment is obtained by superposing a base material 11, a pressure sensitive adhesive layer 12 and a release sheet 13, and the release sheet 13 is peeled off when the masking tape 1 is used.

The tearing resistance of the base material 11 in the width direction must be of 220 mN/15 mm or more, preferably of 230 to 300 mN/15 mm. Since the masking tape has along shape, as described above, when a large stress is applied, such as during peeling off the slide rail 2, tape breakage is likely to occur, with the fracture surface extending normally in the width direction. Herein, however, tape breakage can be prevented by using the base material 11 having a tearing resistance of 220 mN/15 mm or more in the width direction.

When the base material 11 comprises a material in which a machine direction is generated during manufacture, for instance a resin film, the machine direction (MD) of the base material 11 is preferably made into the longitudinal direction of the masking tape 1, and the tearing resistance in the direction perpendicular to the machine direction of the base material 11 (cross-machine direction: CD) is preferably 220 mN/15 mm or more (see FIG. 1). Ordinarily, the tearing resistance in the cross-machine direction is higher than the tearing resistance in the machine direction, and hence the base material 11 can be used with good efficiency by matching the direction where tape breakage is likely to occur with the direction in which the tearing resistance of the base material 11 is higher. If the tearing resistance of the base material 11 in the machine direction is 220 mN/15 mm or more, the cross-machine direction of the base material 11 may be made into the longitudinal direction of the masking tape 1.

As a material of the base material 11 there may be used a material having the above tearing resistance as well as heat resistance at the coating drying temperature, and having also resistance to solvent against the coating employed. As regards heat resistance, a material having a melting point of 180° C. or above is preferably used since the upper limit of the coating drying temperature is ordinarily less than 180° C.

Examples of materials for the base material 11 that satisfy the above conditions include, for instance, a polyethylene terephthalate film, a polyethylene naphthalate film, a polyimide film, a polyetherimide film, a polyaramide film, a polyether ketone film, a polyether ether ketone film, a polyphenylene sulfide film, a poly(4-methylpenten-1) film and the like. These films may be used singly, or laminated with different types of films among the above films, or laminated the above films and films other than the above films together. In terms of versatility, heat resistance, dimensional stability and the like, a polyethylene terephthalate film is preferred among the above films.

The thickness of the base material 11 ranges ordinarily from about 20 to 300 μm, preferably from 30 to 150 μm. When the thickness of the base material 11 is less than 20 μm, it becomes difficult to achieve the above tearing resistance, while when the thickness of the base material 11 exceeds 300 μm, the ability to conform to the convexoconcave of the inner bottom face 231 of the slide rail 2 (in particular the bent portion) decreases, and adhesion using a jig becomes difficult.

The type of pressure sensitive adhesive comprised by the pressure sensitive adhesive layer 12 is not particularly limited, provided that it withstands the coating process and the coating drying process and allows normal masking to be carried out on the slide rail 2. Preferably, however, the pressure sensitive adhesive has an adhesive strength (according to JIS Z0237) of 4 to 10 N/15 mm, more preferably, in particular, of 5 to 9 N/15 mm against a stainless-steel adherend after heating at 180° C. for 1 hour. Herein, “180° C.” is taken as the temperature upper limit during coating drying, and “stainless steel adherend” is taken as the material of the slide rail 2.

When the above adhesive strength is less than 4 N/15 mm, the masking tape 1 may lift up during the coating drying process, while when the adhesive strength exceeds 10 N/15 mm, the masking tape 1 is harder to peel off the adherend, which increase the likelihood of tape breakage.

As pressure sensitive adhesives having such the adhesive strength there can be used herein, for instance, pressure sensitive adhesives having a resin as a main component, for instance a rubber resin, an acrylic resin, an ethylene-vinyl acetate copolymer, a polyurethane resin, a polyester resin, a silicone resin or the like. In terms of heat resistance, durability and the like, a pressure sensitive adhesive having a main component of silicone resin (silicone pressure sensitive adhesive) is preferred herein among the above pressure sensitive adhesives.

The silicone pressure sensitive adhesive may be, for instance, a silicone pressure sensitive adhesive comprising, as a main component thereof, polymethylsiloxane and/or polyphenylsiloxane, as well as a cross-linking agent such as a peroxide or the like, a tackifier, a plasticizer, a filler and the like, as desired.

The thickness of the pressure sensitive adhesive layer 12 is ordinarily of about 5 to 60 μm, preferably of 10 to 40 μm.

As the release sheet 13 there can be used a conventional release sheet, for instance, a release sheet comprising a paper substrate such as glassine paper, coated paper, cast coated paper or the like; a laminate paper in which a thermoplastic resin such as polyethylene or the like is laminated onto such a paper substrate; or a release sheet in which a release agent such as a silicone resin, an alkyd resin, a fluororesin or the like is applied onto a plastic film, for instance a polyester film such as a polyethylene terephthalate film, a polybutylene terephthalate film, a polyethylene naphthalate film or the like; or a polyolefin film of polypropylene, polyethylene or the like.

The thickness of the release sheet 13 is not particularly limited, and ranges ordinarily from about 20 to 150 μm.

The visible light transmission of the masking tape 1 having the release sheet 13 stripped therefrom (laminate of the base material 11 and the pressure sensitive adhesive layer 12) is preferably of 40 to 90%, more preferably, in particular, of 45 to 85%. The haze of the masking tape 1 is preferably of 5 to 98%, more preferably, in particular, of 80 to 96%. When air becomes trapped during adhesion of the masking tape 1, i.e. when air inclusions form between the pressure sensitive adhesive layer 12 and the adherend, the portion in which air is trapped lifts up during coating drying, which may cause the masking tape 1 to peel off. When the visible light transmission and the haze of the masking tape 1 lie within the above ranges, however, it becomes easier to judge whether air has become trapped during adhesion of the masking tape 1. This allows re-sticking the tape when air is judged to have become trapped.

Methods of controlling the visible light transmission and haze of the masking tape 1 include, for instance, roughening the surface (front face) of the base material 11 where the pressure sensitive adhesive layer 12 is not formed, and/or adding a dyestuff and/or a filler or the like, such as calcium carbonate, aluminum paste or silica gel to the base material 11 (or partial layers thereof, when the base material 11 is a laminate) and/or to the pressure sensitive adhesive layer 12. In the former case, the surface roughness (Ra) of the surface of the base material 11 is preferably of 0.05 to 0.80 μm, more preferably, in particular, of 0.08 to 0.60 μm. The method used for achieving such surface roughness is not particularly limited, and may involve sandblasting of the surface of the base material 11, or forming on the surface of the base material 11 a coat layer of a coating agent containing particles of a predetermined particle size.

The masking tape 1 may be manufactured, for instance, by forming the pressure sensitive adhesive layer 12 on one face of the base material 11 through direct application of a pressure sensitive adhesive and superposing the release-treated face of the release sheet 13 onto the pressure sensitive adhesive layer 12, or by forming the pressure sensitive adhesive layer 12 through application of the pressure sensitive adhesive onto the release-treated face of the release sheet 13, and then superposing the pressure sensitive adhesive layer 12 onto one face of the base material 11.

The release sheet 13 is peeled off during use of the masking tape 1, whereupon the exposed pressure sensitive adhesive layer 12 is stuck on the inner bottom face 231 of the slide rail 2 (see FIG. 4). Herein, the masking tape 1 can be stuck on the inner bottom face 231 of the slide rail 2 while the release sheet 13 is being peeled off, using the jig described in the above-described Patent document 1.

A coating process and a coating drying process are carried out thereafter, and then the masking tape 1 is peeled off from the slide rail 2. Since the masking tape 1 has herein the above-described tearing resistance, it can be peeled off without being occurred tape breakage.

The above embodiment has been described for facilitating understanding of the present invention, and not for limiting the present invention. The various elements described in the above embodiment are thus deemed to also include all design modifications and equivalents falling under the technical scope of the present invention.

For instance, the release sheet 13 may be omitted in the masking tape 1.

### EXAMPLES

Following is amore detailed description of the present invention through examples and so on; however, the scope of the present invention is not limited by these examples and so on.

### Example 1

As the base material there was prepared a polyethylene terephthalate film (matte Lumirror #100, by Toray Co., Ltd.; melting point 250° C.) having a thickness of 100 μm, a tearing resistance of 210 mN/15 mm in the machine direction, and a tearing resistance of 250 mN/15 mm in the cross-machine direction, of which one surface was sandblasted. The tearing resistance was measured in accordance with JIS P8112 (similarly hereinafter).

As the silicone pressure sensitive adhesive there was prepared a blend of 60 parts by weight of an addition-curable silicone pressure sensitive adhesive (SD-4580, by Dow Corning Toray Co., Ltd.), 40 parts by weight of an addition-curable silicone pressure sensitive adhesive (SD-4584, by Dow Corning Toray Co., Ltd.), and 1.8 parts by weight of a catalyst (SRX212 by Dow Corning Toray Co., Ltd.).

The above silicone pressure sensitive adhesive was applied such that the thickness after drying would be 20 μm onto then on-sand blasted face of the above base material, then the material was dried at 150° C. for 1 minute to form thereon a pressure sensitive adhesive layer. A masking tape was then prepared by cutting the obtained laminate to a width of 15 mm and a length of 500 mm, making the machine direction of the base material into the longitudinal direction, and the cross-machine direction into the width direction.

### Example 2

As the base material there was prepared a polyethylene terephthalate film (PET T-Toray 100, by Toray Co., Ltd.; melting point 260° C.) having a thickness of 100 μm, a tearing resistance of 215 mN/15 mm in the machine direction, a tearing resistance of 270 mN/15 mm in the cross-machine direction, and having a white coating layer formed on one face of the film.

As the silicone pressure sensitive adhesive there was prepared a blend of 40 parts by weight of an addition-curable silicone pressure sensitive adhesive (SD-4580, by Dow Corning Toray Co., Ltd.), 60 parts by weight of an addition-curable silicone pressure sensitive adhesive (SD-4584, by Dow Corning Toray Co., Ltd.), and 1.8 parts by weight of a catalyst (SRX212 by Dow Corning Toray Co., Ltd.).

The above silicone pressure sensitive adhesive was applied such that the thickness would be 20 μm onto the face of the above base material where no white coating layer was formed, after which a masking tape was produced in the same way as in Example 1.

### Example 3

A masking tape was produced in the same way as in Example 1 but using herein the silicone pressure sensitive adhesive of Example 2 as the pressure sensitive adhesive.

### Comparative Example 1

As the base material there was prepared a transparent polyethylene terephthalate film (T600, by Diafoil Co.; melting point 240° C.) having a thickness of 100 μm, a tearing resistance of 170 mN/15 mm in the machine direction, and a tearing resistance of 210 mN/15 mm in the cross-machine direction.

As the silicone pressure sensitive adhesive there was prepared a blend of 90 parts by weight of an addition-curable silicone pressure sensitive adhesive (SD-4580, by Dow Corning Toray Co., Ltd.), 10 parts by weight of an addition-curable silicone pressure sensitive adhesive (SD-4584, by Dow Corning Toray Co., Ltd.), and 1.8 parts by weight of a catalyst (SRX212 by Dow Corning Toray Co., Ltd.).

The above silicone pressure sensitive adhesive was applied such that the thickness after drying would be 20 μm onto one face of the above base material, after which a masking tape was produced in the same way as in Example 1.

### Test Example

Visible light transmission, haze, surface roughness (Ra) and adhesive strength of the masking tapes obtained in the Examples and Comparative example were measured, and the masking tapes were tested as well for tape lifting, tape breakage and air inclusion, as described below. The results are given in Table 1.

The visible light transmission and the haze were measured in accordance with JIS K6714, while the surface roughness (Ra) was measured in accordance with JIS B0601. The masking tape was stuck on a stainless steel plate, was left to stand for 1 hour, was then heated for 1 hour at 180° C. in a thermostatic chamber, and was left to stand once more for 1 hour under room temperature, after which adhesive strength was measured in accordance with JIS Z0237.

Tape lifting test: The masking tape was stuck on a stainless steel plate, and was left to stand for 1 hour, after which it was heated for 1 hour at 180° C. in a thermostatic chamber. The masking tape was then removed from the chamber and the occurrence of tape lifting was checked visually.

Tape breakage test: The masking tape was stuck on a stainless steel plate, was left to stand for 1 hour, was then heated for 1 hour at 180° C. in a thermostatic chamber, and was left to stand once more for 1 hour under room temperature, after which the masking tape was peeled off in the 180° direction, at a speed of 300 mm/min, using a tensile tester (TENSILON RTA-100, by Orientec Co., Ltd.), to test whether tape breakage occurs in the masking tape.

Air inclusion test: The masking tape was stuck on a stainless steel plate, and then air inclusions having a diameter of about 2 mm were caused to be trapped using a squeegee, to test whether it was possible to check the trapped air visually.

TABLE 1

| | | | | Comparative |
|---|---|---|---|---|
| | Example 1 | Example 2 | Example 3 | example 1 |
| Tearing | 250 | 270 | 250 | 210 |
| resistance in | | | | |
| width direction | | | | |
| (mN/15 mm) | | | | |
| Visible light | 84 | 45 | 84 | 93 |
| transmission (%) | | | | |
| Haze (%) | 85 | 96 | 85 | 3 |
| Surface | 0.50 | 0.10 | 0.50 | 0.02 |
| roughness Ra (μm) | | | | |
| Adhesive | 7 | 9 | 9 | 3 |
| strength | | | | |
| (N/15 mm) | | | | |
| Tape lifting | No | No | No | Yes |
| Tape breakage | No | No | No | Yes |
| Air-inclusion | Possible | Possible | Possible | Not possible |
| check | | | | |

As is seen from Table 1, no tape breakage occurs in the masking tape when the tearing resistance of the base material in the width direction is 220 mN/15 mm or more, no tape lifting occurs when the adhesive strength is 4 N/15 mm or more, while air inclusion can be checked when the visible light transmission ranges from 40 to 90% and the haze from 5 to 98%.

### INDUSTRIAL APPLICABILITY

The masking tape of the present invention is ideal, in particular, for masking the inner bottom face of slide rails for automobile slide doors.

1. A masking tape for a long part, comprising a base material and a pressure sensitive adhesive layer,
wherein the tearing resistance of said base material in the width direction is 220 mN/15 mm or more.

2. The masking tape according to claim 1,
wherein said base material comprises a material in which a machine direction is generated during manufacture;
the machine direction of said base material is a longitudinal direction of said masking tape;
and the tearing resistance of said base material in a direction perpendicular to the machine direction is 220 mN/15 mm or more.

3. The masking tape according to claim 1, wherein said base material comprises a material having a melting point of 180° C. or above.

4. The masking tape according to claim 1, wherein the adhesive strength against a stainless-steel adherend after heating at 180° C. for 1 hour is 4 to 10 N/15 mm.

5. The masking tape according to claim 1, having a width of 5 to 20 mm and a length of 450 mm or more.

6. The masking tape according to claim 1, wherein the masking tape is a masking tape for masking an inner bottom face of a slide rail for an automobile slide door.

7. The masking tape according to claim 2, wherein said base material comprises a material having a melting point of 180° C. or above.

8. The masking tape according to claim 2, wherein the adhesive strength against a stainless-steel adherend after heating at 180° C. for 1 hour is 4 to 10 N/15 mm.

9. The masking tape according to claim 3, wherein the adhesive strength against a stainless-steel adherend after heating at 180° C. for 1 hour is 4 to 10 N/15 mm.

10. The masking tape according to claim 2, having a width of 5 to 20 mm and a length of 450 mm or more.

11. The masking tape according to claim 3, having a width of 5 to 20 mm and a length of 450 mm or more.

12. The masking tape according to claim 4, having a width of 5 to 20 mm and a length of 450 mm or more.

13. The masking tape according to claim 2, wherein the masking tape is a masking tape for masking an inner bottom face of a slide rail for an automobile slide door.

14. The masking tape according to claim 3, wherein the masking tape is a masking tape for masking an inner bottom face of a slide rail for an automobile slide door.

15. The masking tape according to claim 4, wherein the masking tape is a masking tape for masking an inner bottom face of a slide rail for an automobile slide door.

16. The masking tape according to claim 5, wherein the masking tape is a masking tape for masking an inner bottom face of a slide rail for an automobile slide door.
